(19) United States
(12) Patent Application Publication
(10) Pub. No.: US 2026/0350228 A1
(43) Pub. Date: Nov. 5, 2026

(54) ACCESS DELEGATION ENABLER FOR APPLICATION PROGRAMMING INTERFACES

(71) Applicant: International Business Machines Corporation, Armonk, NY (US)

(72) Inventors: Akshar KAUL, Bangalore (IN); Vinayaka PANDIT, Bangalore (IN); Sandeep NISHAD, Bangalore (IN); Venkatraman RAMAKRISHNA, Bangalore (IN); Abhishek SINGH, Delhi (IN); Vivek SHARMA, Bangalore (IN)

(21) Appl. No.: 19/195,285

(22) Filed: Apr. 30, 2025

(51) Int. Cl. G06F 21/62; G06F 9/54

(52) U.S. Cl. CPC G06F 21/629; G06F 9/54

(57) ABSTRACT

In some implementations, an access delegation enabler may receive coding information for an application programming interface (API), wherein the API does not support an access delegation protocol, and wherein the API is associated with one or more API functions. The access delegation enabler may analyze the coding information to determine, for each API function, of the one or more API functions, one or more data units accessed by that API function. The access delegation enabler may assign, to each API function, one or more scopes, of a set of scopes associated with the API, based on a least privilege required to access the one or more data units accessed by that API function. The access delegation enabler may configure an API gateway to enable access to the API using the access delegation protocol and based on the one or more scopes assigned to each API function.

### BACKGROUND

This disclosure relates to computer systems, and more specifically, to an access delegation enabler for application programming interfaces.

### SUMMARY

Some aspects described herein relate to a method. The method may include receiving coding information for an application programming interface (API), where the API does not support an access delegation protocol, and where the API is associated with one or more API functions. The method may include analyzing the coding information to determine, for each API function, of the one or more API functions, one or more data units accessed by that API function. The method may include assigning, to each API function, one or more scopes, of a set of scopes associated with the API, based on a least privilege required to access the one or more data units accessed by that API function. The method may include configuring an API gateway to enable access to the API using the access delegation protocol and based on the one or more scopes assigned to each API function.

Some aspects described herein relate to a computer system. The computer system may include a processor set, one or more computer-readable storage media, and program instructions stored on the one or more computer-readable storage media to cause the processor set to perform operations. The operations may include receiving coding information for an API, where the API does not support an access delegation protocol, and where the API is associated with one or more API functions. The operations may include analyzing the coding information to determine, for each API function, of the one or more API functions, one or more data units accessed by that API function. The operations may include assigning, to each API function, one or more scopes, of a set of scopes associated with the API, based on a least privilege required to access the one or more data units accessed by that API function. The operations may include configuring an API gateway to enable access to the API using the access delegation protocol and based on the one or more scopes assigned to each API function.

Some aspects described herein relate to a computer program product. The computer program product may include one or more computer-readable storage media and program instructions stored on the one or more computer-readable storage media to perform operations. The operations may include receiving coding information for an API, where the API does not support an access delegation protocol, and where the API is associated with one or more API functions. The operations may include analyzing the coding information to determine, for each API function, of the one or more API functions, one or more data units accessed by that API function. The operations may include assigning, to each API function, one or more scopes, of a set of scopes associated with the API, based on a least privilege required to access the one or more data units accessed by that API function. The operations may include configuring an API gateway to enable access to the API using the access delegation protocol and based on the one or more scopes assigned to each API function.

### BRIEF DESCRIPTION OF THE DRAWINGS

FIG. 1 is a diagram of an example computing environment for enabling access delegation protocols for APIs described herein.

FIG. 2 is a diagram of an example implementation associated with enabling access delegation protocols for legacy APIs.

FIG. 3 is a diagram of an example implementation associated with mapping incoming requests at an API gateway to API keys or functional identifiers.

FIG. 4 is a diagram of an example implementation associated with mapping API functions to data units.

FIG. 5 is a diagram of another example implementation associated with mapping API functions to data units.

FIG. 6 is a diagram showing examples associated with inferring one or more scopes based on mapping API functions to data units.

FIG. 7 is a diagram associated with assigning one or more scopes to one or more API functions.

FIGS. 8A-8C are diagrams associated with associating one or more access control protocol scopes to a legacy API that does not support an access control protocol.

FIG. 9 is a flowchart of an example process associated with an application delegation enabler for APIs.

### DETAILED DESCRIPTION

The following detailed description of example implementations refers to the accompanying drawings. The same reference numbers in different drawings may identify the same or similar elements.

Legacy APIs often lack support for modern access delegation protocols, making it challenging to integrate legacy APIs within orchestration platforms that require least privilege access and end-to-end auditability. In traditional systems, users are often required to provide excessive privileges to tools or platforms, which can lead to security risks and compliance issues. For instance, a user may need to grant administrative privileges to a tool to perform a specific task, even though the tool only requires read-only access to a particular resource. Existing manual processes or modifications to the legacy API codebase to enable least privilege access can be time-consuming and costly.

Some implementations described herein provide a system and method to enable legacy APIs to leverage access delegation protocols with the principle of least privilege. For example, the system may receive coding information for an API, analyze the coding information to determine data units accessed by each API function, assign scopes to each API function based on a least privilege required to access the data units, and configure an API gateway to enable access to the API using an access delegation protocol and based on the assigned scopes. In some aspects, the API gateway is associated with a token validation and mapping engine that maps the assigned scopes to a respective API key or functional identifier used to access the legacy API. The system may determine the set of scopes by mapping entities or table entries to data units, inferring a preliminary set of scopes, and aggregating the preliminary set of scopes into a final set of scopes.

In this way, the system reduces potential attacks by enabling legacy APIs to leverage access delegation protocols with the principle of least privilege, thus conserving computing, power, and network resources that would have been otherwise consumed by authentication, authorization, and auditing operations associated with excessive privileges. Furthermore, the system provides fine-grained access control, which can lead to improved system scalability, as resources are allocated only as needed to support least privilege access. In this way, the system may conserve processing resources, memory resources, network resources, and/or the like.

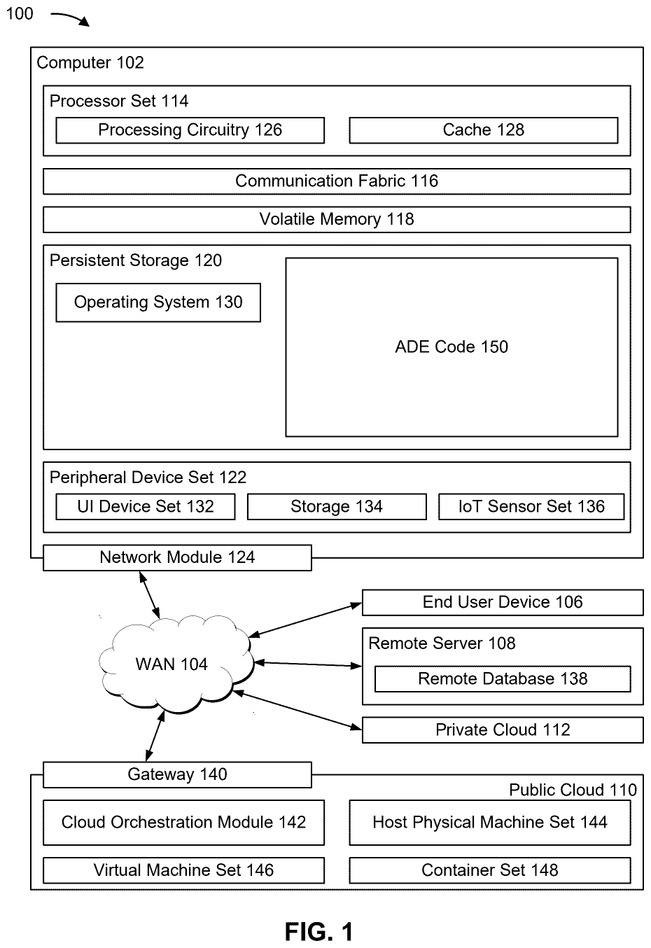

FIG. 1 is a diagram of an example computing environment 100 for enabling access delegation protocols for APIs described herein.

The computing environment 100 contains an example of an environment for the execution of at least some of the computer code involved in performing the inventive methods, such as access delegation enabler (ADE) code 150. In addition to the ADE code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the ADE code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in ADE code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the ADE code 150 typically includes at least some of the computer code involved in performing one or more operations described herein. The operations may include, for example, receiving coding information for an API that does not support an access delegation protocol and that is associated with one or more API functions; analyzing the coding information to determine, for each API function, of the one or more API functions, one or more data units accessed by that API function; assigning, to each API function, one or more scopes, of a set of scopes associated with the API, based on a least privilege required to access the one or more data units accessed by that API function; and configuring an API gateway to enable access to the API using the access delegation protocol and based on the one or more scopes assigned to each API function.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

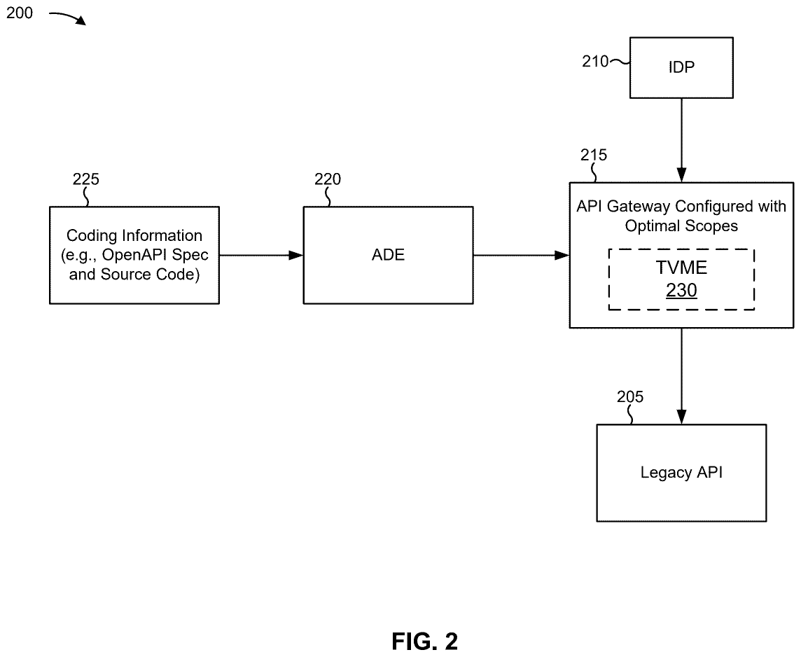

FIG. 2 is a diagram of an example implementation 200 associated with enabling access delegation protocols for legacy APIs. As shown in FIG. 2, example implementation 200 includes a legacy API 205, an identity provider (IDP) 210, an API gateway 215, and an ADE 220. At a high level, the ADE 220 may take coding information 225 associated with the legacy API 205 as input, may determine a set of optimal scopes associated with an access delegation protocol for API functions (e.g., API endpoints, among other examples) associated with the legacy API 205 based on the coding information 225, and may configure the API gateway 215 with the set of optimal scopes. The API gateway 215 may be capable of validating incoming requests for the legacy API 205 using the IDP 210. In some implementations, if a request is valid, the API gateway 215 may map the request to an API key or a functional identifier (ID) that may be used to call the legacy API 205. Moreover, in some implementations, mapping a request to an API key or a functional ID may be carried out by a token validation and mapping engine (TVME) 230 at the API gateway 215. In this way, the example implementation 200 may enable use of access delegation protocols, such as an open authorization (OAuth) protocol (e.g., OAuth 2.0), with legacy APIs that may not otherwise support such protocols.

More particularly, in implementations in which the legacy API 205 does not support a particular access delegation protocol (e.g., OAuth supported by the IDP 210) and the legacy API 205 is to be used in an orchestration platform (such as WatsonX, Orchestrate, CrewAI, AutoGen, or a similar orchestration platform), the ADE 220 may receive the coding information 225 for the legacy API 205. In some implementations, the coding information 225 may include the source code of the legacy API 205 (e.g., a set of instructions and statements written by a programmer using a programming language). Additionally, the coding information 225 may include an OpenAPI specification (OAS) of the legacy API 205 (e.g., a standard format for defining and documenting APIs, such as representational state transfer (RESTful) APIs, that provides a structured way to describe the endpoints, request and response formats, authentication methods, and other aspects of an API in a machine-readable format).

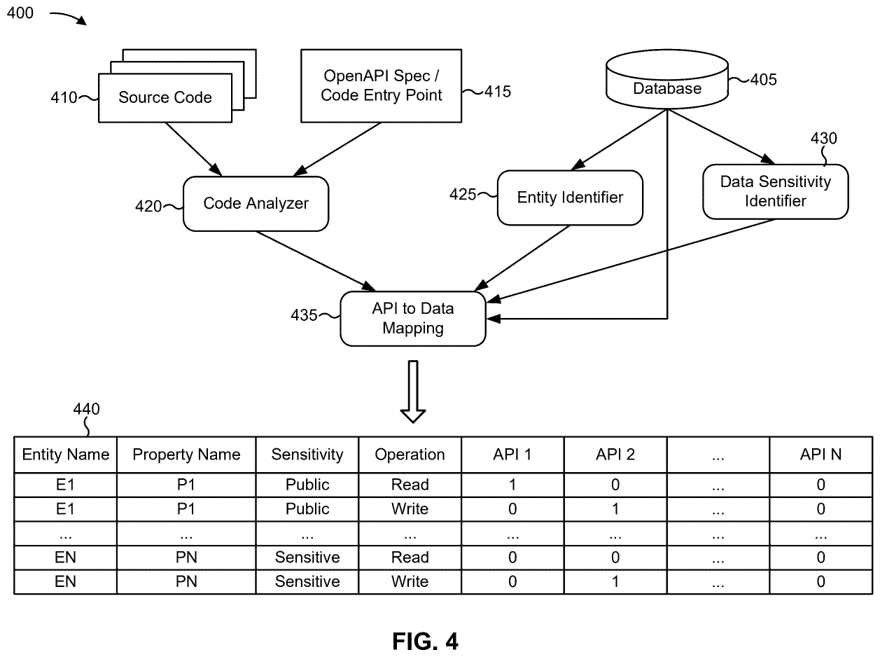

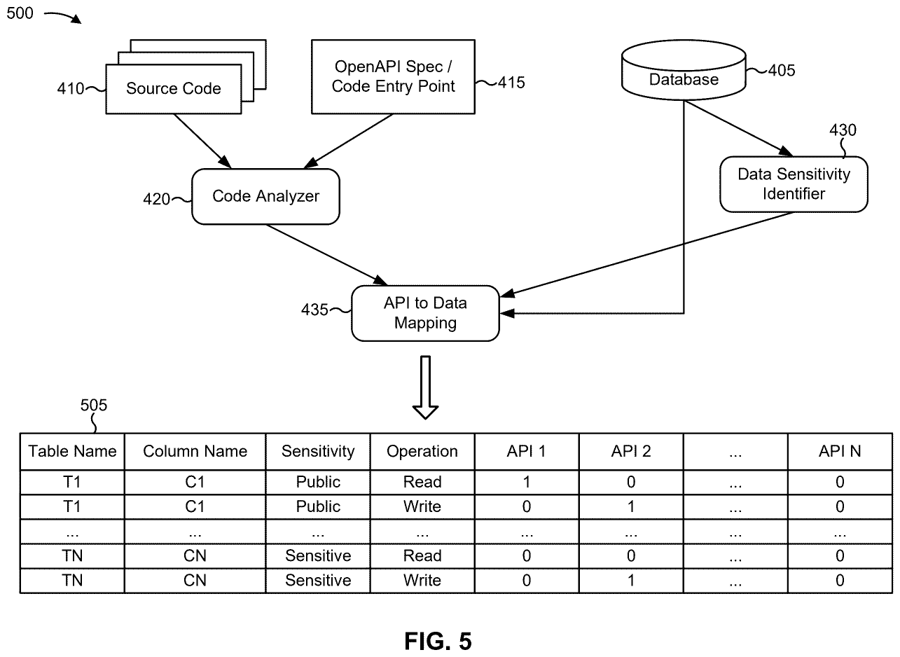

In such implementations, the ADE 220 may analyze the coding information 225 to determine, for each API function or endpoint associated with the legacy API 205, one or more data units accessed by that API function. Put another way, for each API function, the ADE 220 may analyze the coding information 225 (e.g., source code or OAS, among other examples) to find the data units accessed in the API function. In some implementations, the ADE 220 may use one more analyzer components to analyze the coding information 225 to determine one or more data units accessed by that API function. For example, the ADE 220 may use a code analyzer to determine the various data access operations (e.g., read, write, or the like) performed by the API, an entity identifier to identify various entities (e.g., customer, order, or the like) in a database associated with the API, or a data sensitivity identifier to identify a sensitivity level (e.g., public, private, or the like) of the data units accessed by the API, among other examples. Aspects associated with analyzing the coding information 225 using one more analyzer components are described in more detail below in connection with FIGS. 4 and 5.

In some implementations, the ADE 220 may assign, to each API function, one or more scopes based on a least privilege required to access a set of data units associated with that API function. Put another way, the ADE 220 may collect all data units accessed by an API function into a set, and the ADE 220 may infer scopes for these data units based on the least privilege required for respective accesses to the data units. As used herein, “scope” refers to a mechanism to specify and limit the access permissions that a client application is requesting on behalf of a user. In that regard, scopes define the extent of access to the user's resources that the client application is allowed to perform. Scopes enable granting specific levels of access to data without giving full control over an entire account.

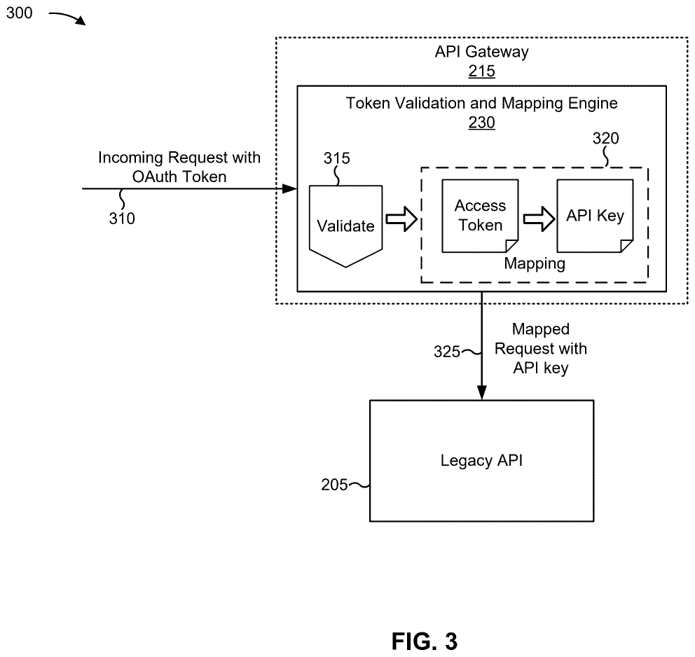

In some implementations, the ADE 220 may configure the API gateway 215 to enable access to the legacy API 205 using the access delegation protocol and based on the one or more scopes assigned to each API function. Put another way, once the ADE 220 has identified the scopes to be assigned to each API function of the legacy API 205, the API gateway 215 may be configured so that the legacy API 205 may leverage the inferred scopes. In that regard, the API gateway 215 may be configured to expose the same set of API endpoints that the legacy system exposes, but the API gateway 215 is configured to require an access delegation enabled token for invocation of the API endpoints exposed by the API gateway. Put another way, the API gateway 215 may be configured to provide access to the legacy API 205 by creating a one-to-one mapping between the one or more API endpoints and API gateway endpoints. In this regard, the API gateway 215 may, using the TVME 230 (among other examples), validate any incoming access requests (e.g., incoming access tokens) directed to an API gateway endpoint, and may accept the access token (e.g., enable access to a corresponding legacy API 205 endpoint) only if the token has the required scope for accessing a particular API endpoint. Aspects regarding validating access requests using the TVME 230 are described in more detail below in connection with FIG. 3.

FIG. 2 is provided as an example. Other examples may differ from what is described with regard to FIG. 2.

FIG. 3 is a diagram of an example implementation 300 associated with mapping incoming requests at an API gateway (e.g., API gateway 215) to API keys or functional IDs.

At a high level, the TVME 230 at the API gateway 215 may bridge a gap between incoming access tokens (e.g., access tokens associated with an access delegation protocol or originating from the IDP 210) and the legacy API 205, which may not otherwise support access tokens or access delegation protocols. More particularly, the TVME 230 may validate incoming tokens (e.g., OAuth tokens) based on scopes, and may map the incoming tokens to the appropriate API key or functional ID for accessing the legacy API 205. In such implementations, the ADE 220 may configure the API gateway 215 to provide access to the legacy API 205 by configuring the API gateway 215 to map, using the TVME 230, the one or more scopes assigned to each API endpoint to a respective API key used to access the legacy API 205 or to a respective functional ID used to access the legacy API 205, among other examples.

More particularly, as indicated by reference number 310, the API gateway 215 may receive access requests and corresponding tokens, such as OAuth tokens, among other examples. In some implementations, the API gateway 215 validates the access token using the IDP 210. The IDP 210 may be a trusted entity that creates, maintains, and manages identity information for users and provides authentication services to other applications or services. In that regard, the IDP 210 may be responsible for verifying the identities of users and issuing authentication tokens (e.g., OAuth tokens) or credentials that can be used by client applications to access protected resources. In some implementations, the IDP 210 may enable single sign-on (SSO) functionality or other functionality associated with user authentication, token issuance, identity management, identity federation, or authorization, among other examples.

In some implementations, the incoming requests and tokens may be forwarded to the TVME 230. As indicated by reference number 315, the TVME 230 may validate the incoming tokens (e.g., OAuth tokens) based on scopes (e.g., the TVME 230 may determine whether a certain request is permitted based on the scopes associated with the access request). Moreover, as indicated by reference number 320, in implementations in which an incoming request is verified, the TVME 230 may perform a mapping operation, in which the TVME 230 may map the access tokens to a corresponding API key or functional ID (shown simply as an API Key in FIG. 3 for ease of description). More particularly, in some implementations, an application may expose an API via API keys or bearer tokens, with a particular API key enabling access to all privileges associated with a corresponding user. In such cases, the TVME 230 may map incoming access tokens (e.g., OAuth tokens) to an API key. In some other implementations, an application may require functional IDs for API access, which may not be integrated with an SSO due to deployment limitations and which may have administrative privileges. In such cases, the TVME 230 may map incoming access tokens (e.g., OAuth tokens) to a functional ID.

As indicated by reference number 325, the API gateway 215 (e.g., the TVME 230 of the API gateway 215) may provide the mapped request and API key or functional ID to the legacy API 205. In this way, the systems and techniques described herein leverage the API gateway 215 (and the TVME 230 therein) to integrate APIs associated with API keys or functional IDs with access delegation protocols, such as SSO using OAuth. Additionally, or alternatively, the systems and techniques described herein use scopes to enable least privilege access delegation, among other examples. Aspects associated with inferring or designing scopes to be used by the API gateway 215 or TVME 230 are described in more detail below in connection with FIGS. 4-7.

FIG. 3 is provided as an example. Other examples may differ from what is described with regard to FIG. 3.

FIG. 4 is a diagram of an example implementation 400 associated with mapping API functions (e.g., API endpoints) to data units. As described above in connection with FIG. 2, in some implementations the ADE 220 may analyze the coding information 225 to determine, for each API function or endpoint, one or more data units accessed by that API function. In some aspects, the data units may be stored in a database 405 associated with the legacy API 205. In some implementations, a particular data unit may be stored in the database 405 using a single table, sometimes referred to herein as a tabular-based format. In such examples, each column or row of the table may correspond to a data unit. However, in some other implementations, data units may be stored in the database 405 using an entity-based format. More particularly, the database 405 may be normalized such that information about a single entity (e.g., customer, order, billing, or the like) is spread across multiple tables. In such implementations, the ADE 220 may use an entity identifier (sometimes referred to as an entity manager) to identify the various entities and database entries that contain information about the entities.

More particularly, example implementation 400 shows an example associated with analyzing entity-based coding information (e.g., coding information 225). More particularly, coding information, such as source code 410, an OAS 415, a code entry point, or similar coding information, may be provided to a code analyzer 420. The code analyzer 420 may identify various API endpoints or functions associated with the coding information. Moreover, the database 405 (which, in this example, may be an entity-based database, as described above) may be provided to an entity identifier 425 and a data sensitivity identifier 430. The entity identifier 425 may identify entities within the database and locations (e.g., table and column entries) that contain information about the identified entities. The data sensitivity identifier 430 may determine sensitivity levels associated with the entities, such as by dividing properties of the entities into public properties and sensitive (e.g., private) properties, among other examples.

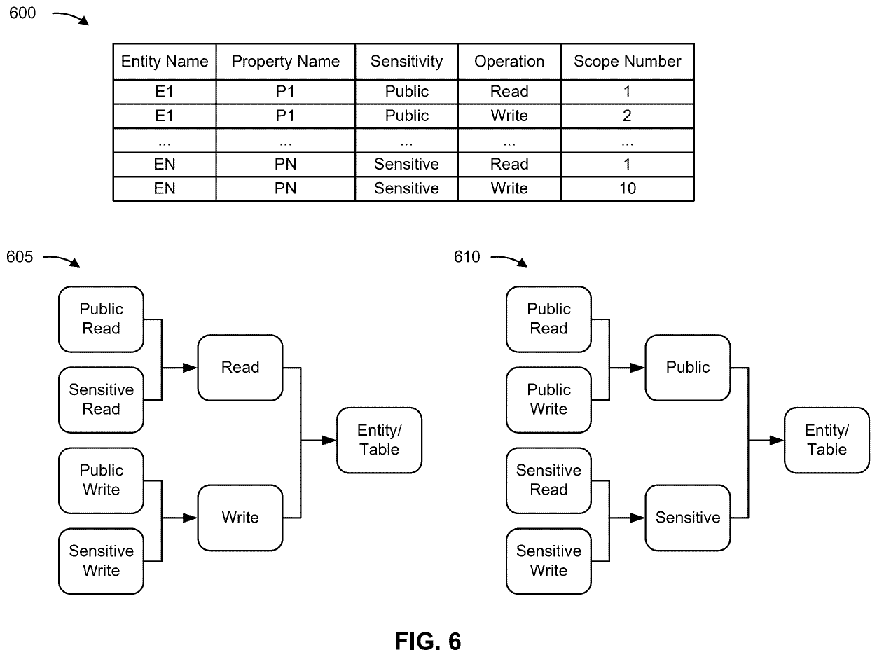

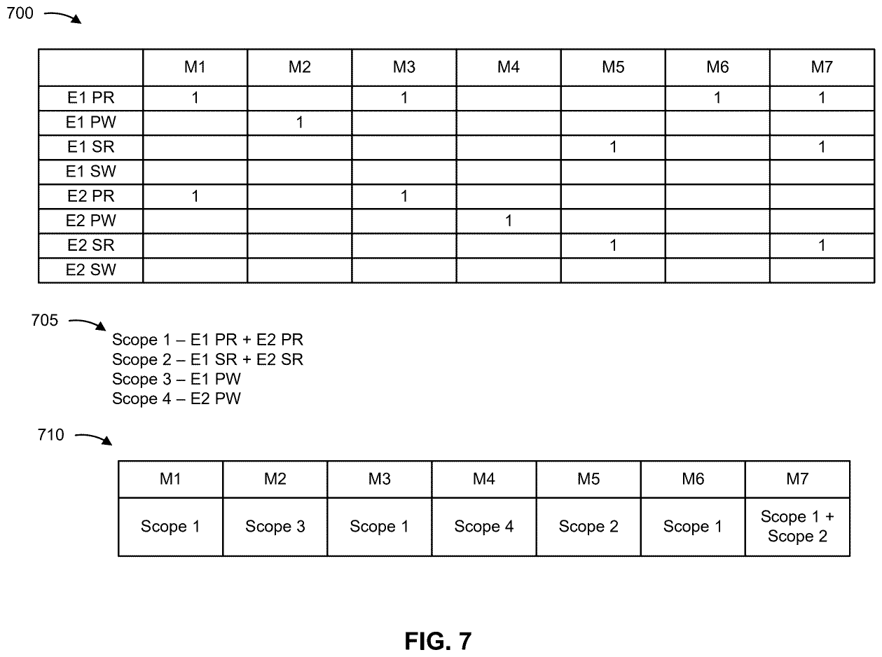

As indicated by reference number 435, the API endpoints or functions (e.g., identified by the code analyzer 420) may be mapped to the data units (e.g., identified by the entity identifier 425 or data sensitivity identifier 430). In some implementations, the API function to data mapping may include creating an API-data mapping table 440 that is used to infer one or more scopes associated with the legacy API 205 (described in more detail below in connection with FIGS. 6 and 7). For example, as shown in FIG. 4, each row of the API-data mapping table 440 may correspond to a unique data unit that may be mapped to various API functions. In this example, the API-data mapping table 440 may include an entity name column (shown in the API-data mapping table 440 as a first entity name, E1, through an N^{th} entity name, EN), a property name column (shown in the API-data mapping table 440 as a first property name, P1, through an N^{th} entity name, PN), a sensitivity level column (shown in the API-data mapping table 440 as one of “public” or “sensitive”), and an operation type column (shown in the API-data mapping table 440 as one of “read” or “write”).

The API-data mapping table 440 may also include corresponding columns for the API functions or endpoints identified by the code analyzer 420, shown in FIG. 4 as “API 1” through “API N.” The columns for the API functions may be used to map whether a particular API endpoint or function accesses a corresponding data unit (e.g., a given row of API-data mapping table 440). For example, a “1” may be used to signify that an API function accesses a corresponding data unit, and a “0” may be used to signify that an API function does not access a corresponding data unit. In that regard, in the example API-data mapping table 440 shown in FIG. 4, API 1 may access a data unit associated with the first row of the table (e.g., a data unit associated with E1, P1, public reads) but API 2 and API N may not access that data unit. Similarly, API 2 may access a data unit associated with the second row of the table (e.g., a data unit associated with E1, P1, public writes) but API 1 and API N may not access that data unit, and so forth. These mappings may, in turn, be used by the ADE 220 or a similar component to infer one or more scopes associated with the legacy API 205, which is described in more detail below in connection with FIGS. 6-7.

FIG. 4 is provided as an example. Other examples may differ from what is described with regard to FIG. 4.

FIG. 5 is a diagram of another example implementation 500 associated with mapping API functions (e.g., API endpoints) to data units. As described above in connection with FIG. 4, in some implementations, a particular data unit may be stored in the database 405 using a single table (e.g., using a tabular-based format). In such examples, each column or row of a table in the database 405 may correspond to a data unit, and thus each row or column of the table in the database 405 may be mapped to one or more API functions.

More particularly, example implementation 500 is associated with analyzing tabular-based coding information (e.g., coding information 225). More particularly, in a similar manner as described above in connection with FIG. 4, coding information (such as the source code 410, the OAS 415, a code entry point, or similar coding information) may be provided to the code analyzer 420. Moreover, the database 405 (which, in this example, may be in a tabular-based format, as described above) may be provided to the data sensitivity identifier 430. Because in this implementation the database stores the data units in a single table or otherwise does not normalize the data or spread the data across multiple tables, the entity identifier 425 described above in connection with FIG. 4 may be omitted. Instead, the data sensitivity identifier 430 may simply determine sensitivity levels associated with each row or column of a table, such as by dividing rows or columns into public and sensitive (e.g., private), among other examples.

In this regard, the API function to data mapping (described above in connection with reference number 435) may include creating an API-data mapping table 505 that is used to infer one or more scopes associated with the legacy API 205 (described in more detail below in connection with FIGS. 6 and 7), with each row of the API-data mapping table 505 corresponding to a data unit (e.g., a row or column of the database 405). In this implementation, the API-data mapping table 505 may include a table name column (shown in the API-data mapping table 505 as a first table name, T1, through an N^{th} table name, TN), a column name column (shown in the API-data mapping table 505 as a first column name, C1, through an N^{th} column name, CN), a sensitivity level column (shown in the API-data mapping table 505 as one of “public” or “sensitive”), and an operation type column (shown in the API-data mapping table 505 as one of “read” or “write”).

Moreover, in a similar manner as described above in connection with the API-data mapping table 440, the API-data mapping table 505 may also include corresponding columns for the API functions or endpoints identified by the code analyzer 420, with a “1” used to signify that an API function accesses a corresponding data unit, and a “0” used to signify that an API function does not access a corresponding data unit. In this regard, in the example API-data mapping table 505 shown in FIG. 5, API 1 may access a data unit associated with the first row of the table (e.g., a data unit associated with T1, C1, public reads) but API 2 and API N may not access that data unit. Similarly, API 2 may access a data unit associated with the second row of the table (e.g., a data unit associated with T1, C1, public writes) but API 1 and API N may not access that data unit, and so forth. These mappings may, in turn, be used by the ADE 220 or similar component to infer one or more scopes associated with the legacy API 205, which is described in more detail below in connection with FIGS. 6-7.

FIG. 5 is provided as an example. Other examples may differ from what is described with regard to FIG. 5.

FIG. 6 is a diagram showing examples associated with inferring one or more scopes based on mapping API functions to data units. In some implementations, the ADE 220 may be capable of inferring the set of scopes to be implemented by the API gateway 215, such as by inferring the set of scopes using one of the API-data mapping tables 440, 505 described above in connection with FIGS. 4-5.

In some implementations, determining the scopes may include striking a balance between inferring too few scopes (which may result in excess permissions attached to access tokens, sometimes referred to herein as permission spilling) and inferring too many scopes (which may lead to many very-fine-grained scopes, resulting in overly complex implementations, sometimes referred to herein as scope explosion). For example, returning to the examples described above in connection with the API-data mapping table 440 and the API-data mapping table 505, defining each row in the tables 440, 505 as a separate scope or else defining each unique combination of API function columns which have 1s as a separate scope may also lead to scope explosion. On the other hand, arbitrarily defining only a few scopes (such as public read, public write, sensitive read, and sensitive write) may result in permission spilling. Accordingly, in some implementations, the ADE 220 may be configured to infer an optimized set of scopes for a given application, such as by inferring a reasonable number of scopes based on the application complexity, that are coherent for certain users (e.g., that enable developers to infer a privilege level associated with a given scope), or that enable least privilege access, among other examples.

More particularly, in some implementations, the ADE 220 may be configured to infer a preliminary set of scopes (sometimes referred to herein as “fine-grained scopes”) based on the mapping entities or table entries of the database 405 to the API functions. More particularly, as shown in FIG. 6, and by reference number 600, the ADE 220 may identify the preliminary set of scopes (with each scope being associated with one or more rows in an API-to-data-mapping table) using an optimization function that is based on a weighted sum of one or more scope objectives. The scope objectives may include reducing a total number of scopes, reducing a number of entities per scope, or reducing permission spilling per scope, among other examples. In such examples, the preliminary set of scopes may include the output shown by reference number 600, such as by inferring a first preliminary scope for the first and next-to-last rows of the API-to-data-mapping table (e.g., scope number 1 in the table indicated by reference number 600), inferring a second preliminary scope for the second row of the API-to-data-mapping table (e.g., scope number 2 in the table indicated by reference number 600), and so forth, through inferring a tenth preliminary scope for the last row of the API-to-data-mapping table (e.g., scope number 10 in the table indicated by reference number 600).

In some implementations, the ADE 220 may aggregate the preliminary set of scopes into an optimized or final set of scopes by consolidating the preliminary set of scopes, such as by combining at least two scopes, of the preliminary set of scopes, into a single scope, of the optimized or final set of scopes. In some implementations, the ADE 220 may consolidate preliminary scopes by consolidating scopes that are used together most often. For example, as shown by reference number 605, preliminary scopes associated with public read and sensitive read operations for a given entity or table may be consolidated into a scope associated with read operations for the given entity or table. Similarly, preliminary scopes associated with public write and sensitive write operations for a given entity or table may be consolidated into a scope associated with write operations for the given entity or table. Moreover, in some examples, the scope associated with the read operations for the given entity or table and the scope associated with the write operations for the given entity or table may be further consolidated into a single scope associated with that entity or table. In other examples, as shown by reference number 610, preliminary scopes associated with public read and public write operations for a given entity or table may be consolidated into a scope associated with public operations for the given entity or table. Similarly, preliminary scopes associated with sensitive read and sensitive write operations for a given entity or table may be consolidated into a scope associated with sensitive operations for the given entity or table. Moreover, in some examples, the scope associated with the public operations for the given entity or table and the scope associated with sensitive operations for the given entity or table may be further consolidated into a single scope associated with that entity or table.

Additionally, or alternatively, in some implementations, the ADE 220 may be capable of providing a hierarchical naming of the scopes based on a hierarchical structure of the data units associated with that scope. Put another way, in some implementations, the ADE 220 may identify a hierarchical order of data associated with the API and name the scopes to reflect the hierarchical order of the data associated with the API. For example, if the data indicates a hierarchical structure in which “orders” encompass “items,” then scopes associated with items may be renamed as “orders::items::*” (with * representing a variable value depending on the specific scope), among other examples. In such implementations, hierarchical naming of the scopes may enable developers to infer permission levels or content associated with each scope, among other examples. After the set of scopes for a given API has been determined, the scopes may be assigned to the API (e.g., various functions of the API), which is described in more detail below in connection with FIG. 7.

FIG. 6 is provided as an example. Other examples may differ from what is described with regard to FIG. 6.

FIG. 7 is a diagram associated with assigning one or more scopes to one or more API functions (e.g., API endpoints). More particularly, as described above in connection with FIG. 2, the ADE 220 may assign, to each API function, one or more scopes associated with the API based on a least privilege required to access the one or more data units accessed by that API function. In some implementations, the ADE 220 may do so by assigning to each API function a minimum set of scopes that cover all the “1s” in the corresponding column of an API-data mapping table (e.g., one of API-data mapping tables 440, 505).

For example, FIG. 7 shows an example API-data mapping table 700 associated with mapping eight data units to seven API functions. The eight data units may be associated with an entity 1 public read data unit (shown in FIG. 7 as “E1 PR”), an entity 1 public write data unit (shown in FIG. 7 as “E1 PW”), an entity 1 sensitive read data unit (shown in FIG. 7 as “E1 SR”), an entity 1 sensitive write data unit (shown in FIG. 7 as “E1 SW”), an entity 2 public read data unit (shown in FIG. 7 as “E2 PR”), an entity 2 public write data unit (shown in FIG. 7 as “E2 PW”), an entity 2 sensitive read data unit (shown in FIG. 7 as “E2 SR”), and an entity 2 sensitive write data unit (shown in FIG. 7 as “E1 SW”). The seven API functions may be abbreviated as “M1” through “M7” in FIG. 7.

In a similar manner as described above in connection with FIGS. 4 and 5, the various API functions may be mapped to the various data units, such as by placing a “1” in the columns corresponding to the API functions (for ease of description, the “0s” in the API function columns have been omitted in FIG. 7). Moreover, in a similar manner as described above in connection with FIG. 6, the ADE 220 may infer one or more scopes for the API (which may include inferring a preliminary set of scopes and then consolidating the preliminary set of scopes into a final or optimized set of scopes). More particularly, as indicated by reference number 705, the ADE 220 may infer four scopes, including a first scope associated with E1 PR and E2 PR, a second scope associated with E1 SR and E2 SR, a third scope associated with E1 PW, and a fourth scope associated with E2 PW. As indicated by reference number 710, the ADE 220 may, in turn, assign to each API function a minimum set of scopes that cover all of the “1s” in the corresponding column of the API-data mapping table 700. For example, the ADE 220 may assign scope 1 to M1, scope 3 to M2, scope 1 to M3, scope 4 to M4, scope 2 to M5, scope 1 to M6, and scopes 1 and 2 to M7. The API gateway 215 may then be configured to enable access to the API using an access delegation protocol (e.g., OAuth) and based on the one or more scopes assigned to each API function.

FIG. 7 is provided as an example. Other examples may differ from what is described with regard to FIG. 7.

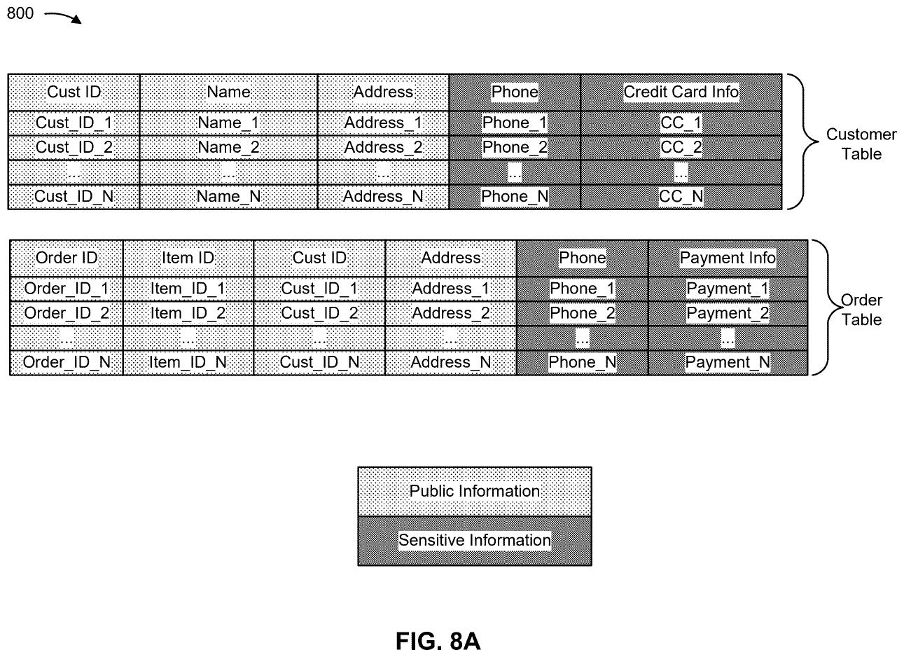

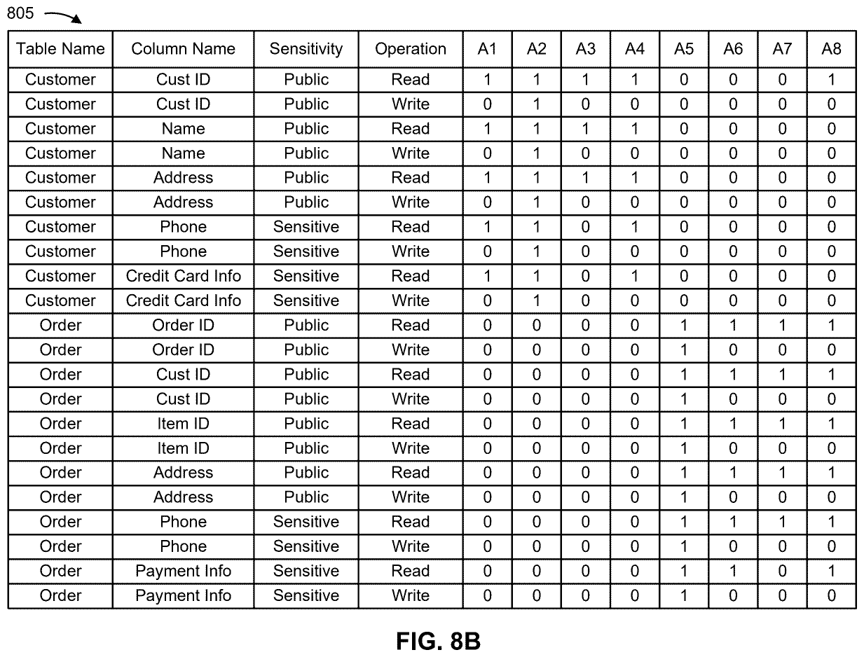

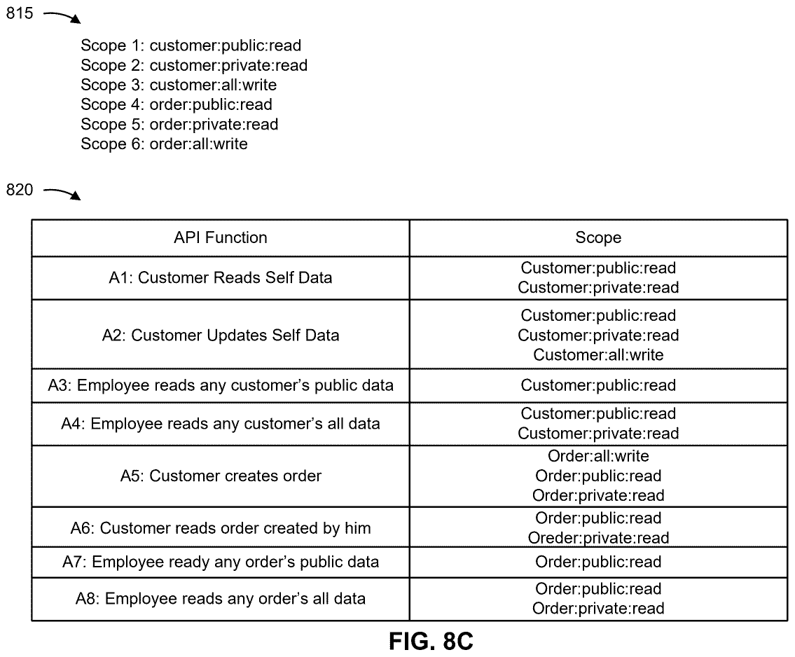

FIGS. 8A-8C are diagrams associated with associating one or more scopes to a legacy API that does not support an access control protocol.

By way of example, the legacy API 205 described above may be associated with a customer resource management (CRM) application for an e-commerce company. In such implementations, and as shown by reference number 800 in FIG. 8A, a database associated with legacy API 205 (e.g., database 405) may include two tables, including a customer table having columns such as customer ID, name, address, phone number, credit card information, or the like; and an order table having columns such as order ID, item ID, customer ID, address, phone number, and payment information, or the like. Accordingly, the ADE 220 (e.g., the data sensitivity identifier 430 of the ADE 220) may divide the columns into columns associated with public information and columns associated with sensitive information. For example, as shown using light stippling in FIG. 8A, the ADE 220 may identify that the customer ID column, the name column, and address column of the customer table are associated with public information, and, as shown using dark stippling in FIG. 8A, that the phone number column and the credit card information column of the customer table are associated with sensitive information. Similarly, the data sensitivity identifier 430 may identify that the order ID column, the item ID column, the customer ID column, and the address column of the order table are associated with public information, and that the phone number column and the payment information column of the order table are associated with sensitive information.

Moreover, the ADE 220 (e.g., the code analyzer 420 of the ADE 220) may determine that the legacy API 205 is associated with eight API functions or endpoints. For example, the ADE 220 may determine that the legacy API 205 is associated with a first API function associated with a customer reading self data (referred to herein as “A1”), a second API function associated with a customer updating self data (referred to herein as “A2”), a third API function associated with an employee reading any customer's public data (referred to herein as “A3”), a fourth API function associated with an employee reading any customer's all data (referred to herein as “A4”), a fifth API function associated with a customer creating an order (referred to herein as “A5”), a sixth API function associated with a customer reading order data for an order created by the customer (referred to herein as “A6”), a seventh API function associated with an employee reading any order's public data (referred to herein as “A7”), and an eighth API function associated with an employee reading any order's all data (referred to herein as “A8”).

In such implementations, the ADE 220 may map the various columns to the API functions described above (e.g., A1 through A8). For example, as shown in FIG. 8B, and by API-data mapping table 805, each of the API functions may be mapped to the columns of the customer table and the order table. As shown in FIG. 8B, a particular column may be mapped to one or more API functions, and, similarly, a particular API function may be mapped to one or more columns. For example, a data unit associated with a customer name in the customer table and with public read operations may be associated with API functions A1 (e.g., a customer reading self data), A2 (e.g., a customer updating self data), A3 (e.g., an employee reading any customer's public data), and A4 (e.g., an employee reading any customer's all data), among other examples.

This mapping may then be used to infer one or more scopes for the legacy API 205, such as in a similar manner as described above in connection with FIGS. 6-7. More particularly, as shown in FIG. 8C, and by reference number 815, the ADE 220 may infer four scopes for the CRM example and may name the scopes using a hierarchal naming convention. For example, a first inferred and named scope may be customer:public:read, a second inferred and named scope may be customer:private:read, a third inferred and named scope may be customer:all:write, a fourth inferred and named scope may be order:public:read, a fifth inferred and named scope may be order:private:read, and a sixth inferred and named scope may be order:all:write. Moreover, as indicated by reference number 820, each API function may be assigned one or more scopes based on a least privilege required to access that API function. For example, A1 may be assigned scopes 1 and 2, A2 may be assigned scopes 1-3, A3 may be assigned scope 1, A4 may be assigned scopes 1 and 2, A5 may be assigned scopes 4-6, A6 may be assigned scopes 4 and 5, A7 may be assigned scope 4, and A8 may be assigned scopes 4 and 5. In this way, the API gateway 215 may be configured with the scopes and the corresponding mapped API functions, and thus the API gateway 215 may enable access to the legacy API 205 using the access delegation protocol and based on the one or more scopes assigned to each API function, as described above in connection with FIGS. 2-3.

FIGS. 8A-8C are provided as examples. Other examples may differ from what is described with regard to FIGS. 8A-8C.

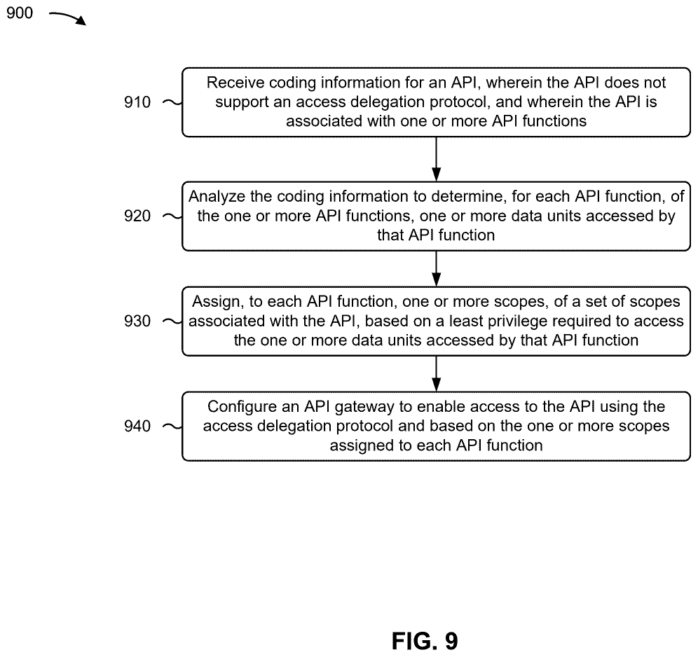

FIG. 9 is a flowchart of an example process 900 associated with an ADE for APIs. One or more process blocks of FIG. 9 are performed by an ADE (e.g., ADE 220) and/or by another device or a group of devices separate from or including the ADE, such as computer (e.g., computer 102), end user device (e.g., EUD 106), remote server (e.g., remote server 108), public cloud (e.g., public cloud 110), private cloud (e.g., private cloud 112), IDP (e.g., IDP 210), API gateway (e.g., API gateway 215), TVME (e.g., TVME 230), code analyzer (e.g., code analyzer 420), entity identifier (e.g., entity identifier 425), or data sensitivity identifier (e.g., data sensitivity identifier 430), among other examples.

As shown in FIG. 9, process 900 includes receiving coding information for an API, wherein the API does not support an access delegation protocol, and wherein the API is associated with one or more API functions (block 910). For example, the ADE 220 may receive coding information for an API, wherein the API does not support an access delegation protocol, and wherein the API is associated with one or more API functions, as described above.

As further shown in FIG. 9, process 900 includes analyzing the coding information to determine, for each API function, of the one or more API functions, one or more data units accessed by that API function (block 920). For example, the ADE 220 may analyze the coding information to determine, for each API function, of the one or more API functions, one or more data units accessed by that API function, as described above.

As further shown in FIG. 9, process 900 includes assigning, to each API function, one or more scopes, of a set of scopes associated with the API, based on a least privilege required to access the one or more data units accessed by that API function (block 930). For example, the ADE 220 may assign, to each API function, one or more scopes, of a set of scopes associated with the API, based on a least privilege required to access the one or more data units accessed by that API function, as described above.

As further shown in FIG. 9, process 900 includes configuring an API gateway to enable access to the API using the access delegation protocol and based on the one or more scopes assigned to each API function (block 940). For example, the ADE 220 may configure an API gateway to enable access to the API using the access delegation protocol and based on the one or more scopes assigned to each API function, as described above.

Process 900 may include additional aspects, such as any single aspect or any combination of aspects described below and/or in connection with one or more other processes described elsewhere herein.

In a first aspect, the API gateway is associated with a token validation and mapping engine, and configuring the API gateway to provide access to the API includes configuring the token validation and mapping engine to map the one or more scopes assigned to each API function to a respective API key used to access the API or to a respective functional identifier used to access the API.

In a second aspect, alone or in combination with the first aspect, the access delegation protocol is associated with an OAuth protocol.

In a third aspect, alone or in combination with one or more of the first and second aspects, process 900 includes determining the set of scopes by mapping one of entities associated with the coding information, or table entries associated with the coding information, to the one or more API functions, inferring a preliminary set of scopes based on the mapping the one of the entities or the table entries to the API functions, and aggregating the preliminary set of scopes into the set of scopes by consolidating at least two scopes, of the preliminary set of scopes, into a single scope, of the set of scopes.

In a fourth aspect, alone or in combination with one or more of the first through third aspects, determining the set of scopes includes providing a hierarchical naming of at least one scope, of the set of the scopes, based on a hierarchical structure of the data units associated with that scope.

In a fifth aspect, alone or in combination with one or more of the first through fourth aspects, providing the hierarchical naming of the at least one scope includes identifying a hierarchical order of data associated with the API, and naming the at least one scope to reflect the hierarchical order of the data associated with the API.

In a sixth aspect, alone or in combination with one or more of the first through fifth aspects, determining the set of scopes includes using an optimization function that is based on a weighted sum of one or more scope objectives.

In a seventh aspect, alone or in combination with one or more of the first through sixth aspects, the coding information includes at least source code associated with the API and, optionally, an OpenAPI specification associated with the API.

In an eighth aspect, alone or in combination with one or more of the first through seventh aspects, analyzing the coding information includes at least one of using a code analyzer to determine data access operations performed by the API, using an entity identifier to identify entities in a database associated with the API, or using a data sensitivity identifier to identify a sensitivity level of data accessed by the API.

In a ninth aspect, alone or in combination with one or more of the first through eighth aspects, configuring the API gateway to provide access to the API includes creating a one-to-one mapping between the one or more API functions and one or more API gateway endpoints.

Although FIG. 9 shows example blocks of process 900, in some implementations, process 900 includes additional blocks, fewer blocks, different blocks, or differently arranged blocks than those depicted in FIG. 9. Additionally, or alternatively, two or more of the blocks of process 900 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving coding information for an application programming interface (API), wherein the API does not support an access delegation protocol, and wherein the API is associated with one or more API functions;
analyzing the coding information to determine, for each API function, of the one or more API functions, one or more data units accessed by that API function;
assigning, to each API function, one or more scopes, of a set of scopes associated with the API, based on a least privilege required to access the one or more data units accessed by that API function; and
configuring an API gateway to enable access to the API using the access delegation protocol and based on the one or more scopes assigned to each API function.

2. The method of claim 1, wherein the API gateway is associated with a token validation and mapping engine, and
wherein configuring the API gateway to provide access to the API includes configuring the token validation and mapping engine to map the one or more scopes assigned to each API function to a respective API key used to access the API or to a respective functional identifier used to access the API.

3. The method of claim 1, wherein the access delegation protocol is associated with an open authorization (OAuth) protocol.

4. The method of claim 1, further comprising determining the set of scopes by:
mapping one of entities associated with the coding information, or table entries associated with the coding information, to the one or more API functions;
inferring a preliminary set of scopes based on the mapping the one of the entities or the table entries to the API functions; and
aggregating the preliminary set of scopes into the set of scopes by consolidating at least two scopes, of the preliminary set of scopes, into a single scope, of the set of scopes.

5. The method of claim 4, wherein determining the set of scopes includes providing a hierarchical naming of at least one scope, of the set of the scopes, based on a hierarchical structure of the data units associated with that scope.

6. The method of claim 5, wherein providing the hierarchical naming of the at least one scope includes:
identifying a hierarchical order of data associated with the API; and
naming the at least one scope to reflect the hierarchical order of the data associated with the API.

7. The method of claim 4, wherein determining the set of scopes includes using an optimization function that is based on a weighted sum of one or more scope objectives.

8. The method of claim 1, wherein the coding information includes at least source code associated with the API, and, optionally, an OpenAPI specification associated with the API.

9. The method of claim 1, wherein analyzing the coding information includes at least one of:
using a code analyzer to determine data access operations performed by the API, using an entity identifier to identify entities in a database associated with the API, or using a data sensitivity identifier to identify a sensitivity level of data accessed by the API.

10. The method of claim 1, wherein the configuring the API gateway to provide access to the API includes creating a one-to-one mapping between the one or more API functions and one or more API gateway endpoints.

11. A computer system comprising:
a processor set;
one or more computer-readable storage media; and
program instructions stored on the one or more computer-readable storage media to cause the processor set to perform operations comprising:
receiving coding information for an application programming interface (API), wherein the API does not support an access delegation protocol, and wherein the API is associated with one or more API functions;
analyzing the coding information to determine, for each API function, of the one or more API functions, one or more data units accessed by that API function;
assigning, to each API function, one or more scopes, of a set of scopes associated with the API, based on a least privilege required to access the one or more data units accessed by that API function; and
configuring an API gateway to enable access to the API using the access delegation protocol and based on the one or more scopes assigned to each API function.

12. The computer system of claim 11, wherein the API gateway is associated with a token validation and mapping engine, and
wherein configuring the API gateway to provide access to the API includes configuring the token validation and mapping engine to map the one or more scopes assigned to each API function to a respective API key used to access the API or to a respective functional identifier used to access the API.

13. The computer system of claim 11, wherein the operations further comprise determining the set of scopes by:
mapping one of entities associated with the coding information, or table entries associated with the coding information, to the one or more API functions;
inferring a preliminary set of scopes based on the mapping the one of the entities or the table entries to the one or more API functions; and
aggregating the preliminary set of scopes into the set of scopes by consolidating at least two scopes, of the preliminary set of scopes, into a single scope, of the set of scopes.

14. The computer system of claim 13, wherein determining the set of scopes includes providing a hierarchical naming of at least one scope, of the set of the scopes, based on a hierarchical structure of the data units associated with that scope.

15. The computer system of claim 14, wherein providing the hierarchical naming of the at least one scope comprises:
identifying a hierarchical order of data associated with the API; and
naming the at least one scope to reflect the hierarchical order of the data associated with the API.

16. The computer system of claim 13, wherein determining the set of scopes comprises using an optimization function that is based on a weighted sum of one or more scope objectives.

17. A computer program product comprising:
one or more computer-readable storage media; and
program instructions stored on the one or more computer-readable storage media to perform operations comprising:
receiving coding information for an application programming interface (API), wherein the API does not support an access delegation protocol, and wherein the API is associated with one or more API functions;
analyzing the coding information to determine, for each API function, of the one or more API functions, one or more data units accessed by that API function;
assigning, to each API function, one or more scopes, of a set of scopes associated with the API, based on a least privilege required to access the one or more data units accessed by that API function; and
configuring an API gateway to enable access to the API using the access delegation protocol and based on the one or more scopes assigned to each API function.

18. The computer program product of claim 17, wherein the coding information includes at least source code associated with the API, and, optionally, an OpenAPI specification associated with the API.

19. The computer program product of claim 17, wherein analyzing the coding information comprises at least one of:
using a code analyzer to determine data access operations performed by the API,
using an entity identifier to identify entities in a database associated with the API, or
using a data sensitivity identifier to identify a sensitivity level of data accessed by the API.

20. The computer program product of claim 17, wherein the configuring the API gateway to provide access to the API comprises:
creating a one-to-one mapping between the one or more API functions and one or more API gateway endpoints; and
assigning one or more scopes to each API gateway function.
